(19) United States
(12) Patent Application Publication
(10) Pub. No.: US 2021/0390091 A1
(43) Pub. Date: Dec. 16, 2021

(54) INTERACTIVE CONTINUOUS IN-DEVICE TRANSACTION PROCESSING USING KEY-VALUE (KV) SOLID STATE DRIVES (SSDS)

(71) Applicant: Samsung Electronics Co., Ltd., Suwon-si (KR)

(72) Inventors: YANGWOOK KANG, San Jose, CA (US); PRATIK MISHRA, San Jose, CA (US); YANG SEOK KI, Palo Alto, CA (US)

(21) Appl. No.: 16/992,096

(22) Filed: Aug. 12, 2020

Related U.S. Application Data
(60) Provisional application No. 63/039,979, filed on Jun. 16, 2020.

(51) Int. Cl. G06F 16/23; G06F 16/22; G06F 7/14; G06F 13/16

(52) U.S. Cl. CPC G06F 16/2379; G06F 13/1668; G06F 7/14; G06F 16/2228

(57) ABSTRACT

Various aspects include an interactive continuous in-device KV transaction processing system and method. The system includes a host device and a KV-SSD. The KV-SSD includes a command handler module to receive and process command packets from the host device, to identify KV input/output (I/O) requests associated with a KV transaction, and to prepare a per-transaction index structure. The method includes receiving a command packet from a host device, and determining, by the command handler module, whether a transaction tag associated with the KV transaction is embedded in the command packet. Based on determining that the transaction tag is not embedded in the command packet, the method includes processing one or more KV I/O requests using a main KV index structure. Based on determining that the transaction tag is embedded in the command packet, the method includes individually processing the one or more KV I/O requests using a per-transaction index structure.

### RELATED APPLICATION DATA

This application claims the benefit of U.S. Provisional Application Ser. No. 63/039,979, filed on Jun. 16, 2020, which is hereby incorporated by reference.

### TECHNICAL AREA

The present embodiments relate to key-value (KV) storage systems, and more particularly, to systems and methods for providing interactive continuous in-device transaction processing using KV solid state drives (KV-SSDs).

### BACKGROUND

Transactions are an integral part of a KV storage system, ensuring the consistency of KV-pairs to applications. The transactions may be implemented using a batch operation where a group of KV pairs may be staged in-memory and sent to the underlying device. The underlying device may be stateless. However, because large batch writes may not be done atomically, additional redundancies such as a journal or write ahead log (WAL) may be required, thereby increasing write amplification, thus achieving suboptimal performance and reducing the lifetime of devices.

Offloading batch transactions to storage devices may help alleviate the side effects of batch transactions, but problems may persist because the size of the transaction may be limited by the size of write buffers in the device. Moreover, applications running on a host still may need to keep the entire transaction in memory while it is being processed by a device. Thus, sharing the transaction with other applications running in the same or different storage nodes is difficult. It may be difficult or impossible to share with others a dynamic view of data based on output of individual requests.

### BRIEF SUMMARY

Various embodiments of the disclosure include an interactive continuous in-device KV transaction processing system. The KV transaction processing system may include a host device configured to generate a command packet, and a KV-SSD. The KV-SSD may include a command handler module configured to receive the command packet from the host device. The command handler module may be further configured to detect a KV transaction within the command packet. The command handler module may be further configured to identify one or more KV input/output (I/O) requests associated with the KV transaction. The command handler module may be further configured to at least one of i) prepare a new per-transaction index structure or ii) select a pre-existing per-transaction index structure associated with the KV transaction. The KV-SSD may include a transaction I/O engine configured to individually process the one or more KV I/O requests of the per-transaction index structure. The host device may be configured to commit or rollback the KV transaction.

A method for processing an interactive continuous in-device KV transaction may include receiving, by a command handler module of a KV-SSD, a command packet. The method may include determining, by the command handler module, whether a transaction tag associated with a KV transaction is embedded in the command packet. The method may include, based on determining that the transaction tag is not embedded in the command packet, processing one or more KV I/O requests associated with the KV transaction using a main KV index structure. The method may include, based on determining that the transaction tag is embedded in the command packet, processing the one or more KV I/O requests associated with the KV transaction based on at least one of i) a new per-transaction index structure or ii) a pre-existing per-transaction index structure associated with the KV transaction.

### BRIEF DESCRIPTION OF THE DRAWINGS

The foregoing and additional features and advantages of the present disclosure will become more readily apparent from the following detailed description, made with reference to the accompanying figures, in which:

FIG. 1 illustrates a block diagram of a KV storage system in accordance with some embodiments.

FIG. 2 is a block and flow diagram illustrating a technique for processing KV transactions in accordance with some embodiments.

FIG. 3 is a block and flow diagram illustrating a technique for performing interactive continuous in-device transaction processing using a KV-SSD 110 in accordance with some embodiments.

FIG. 4 is a flow diagram illustrating a technique for processing commands received by the command handler module in accordance with some embodiments.

FIG. 5 illustrates a block diagram of a per-transaction index structure in accordance with some embodiments.

FIG. 6 is a flow diagram illustrating a technique for handling KV I/O requests by a transaction I/O engine in accordance with some embodiments.

FIG. 7 is a flow diagram illustrating a technique for completing KV transactions sent to the KV-SSD in accordance with some embodiments.

### DETAILED DESCRIPTION

Reference will now be made in detail to embodiments disclosed herein, examples of which are illustrated in the accompanying drawings. In the following detailed description, numerous specific details are set forth to enable a thorough understanding of the inventive concept. It should be understood, however, that persons having ordinary skill in the art may practice the inventive concept without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first transaction could be termed a second transaction, and, similarly, a second transaction could be termed a first transaction, without departing from the scope of the inventive concept.

The terminology used in the description of the inventive concept herein is for the purpose of describing particular embodiments only and is not intended to be limiting of the inventive concept. As used in the description of the inventive concept and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

Embodiments disclosed herein address limitations with in-device batch transactions, for example, by adding an interactive and continuous transaction processing mechanism to KV storage systems and devices such as KV-SSDs. Some KV storage systems may use transactions to ensure consistency of KV-pairs to applications. Transactions may generally be implemented using a wait-batch-submit mechanism, where a group of independent KV pairs may be staged in-memory inside a transaction, on a host device, and sent to an underlying device at once (e.g., as a single transaction). Some storage devices may have near-data processing capabilities, such as KV-SSDs, which can offload many host-side KV functionalities to the device. Such KV-SSDs may implement in-device transaction management, where the main principle remains the same, i.e., all requests in a transaction are submitted and are processed in batch, which is different than transactions implemented in database systems, where the owner of the transactions can view the status of individual requests in the transactions.

This disclosure provides a mechanism to manage transactions interactively and continuously in KV storage devices such as KV-SSDs. The disclosed system may provide seamless, continuous processing of individual requests belonging to a transaction while providing status to applications individually.

This disclosure covers a variety of ways to implement transactions in KV-SSD devices. There may be two types of transactions: batch and continuous. In addition, this disclosure introduces a mechanism to support continuous and interactive transactions in KV-SSDs, where individual KV requests in a transaction may be submitted to the KV-SSDs, and status may be made available to the applications that hold the transaction ID even while the complete transaction has not ended. Some techniques of staging the requests, which may submit to a device in-batch, and wait for the completion of all requests inside the transaction to retrieve the results for individual requests, increase the over-all latency and resource usage. Moreover, due to a continuous in-order management of individual requests, the applications running on the host device may make dynamic decisions, which is not provided by existing techniques of batch transaction processing.

The embodiments disclosed herein are advantageous because the approach is closer to application semantics, more scalable to support large transactions, dynamic in the sense that a dynamic view of data based on output of individual requests can be made available, more efficient because journaling is not required, and easier to fill the bandwidth of data (e.g., no buffered asynchronous IO processing is required). Compared to some KV stores, the interactive transaction mechanism disclosed herein may eliminate the need for transaction logging, thereby providing flexibility to choose to commit or rollback.

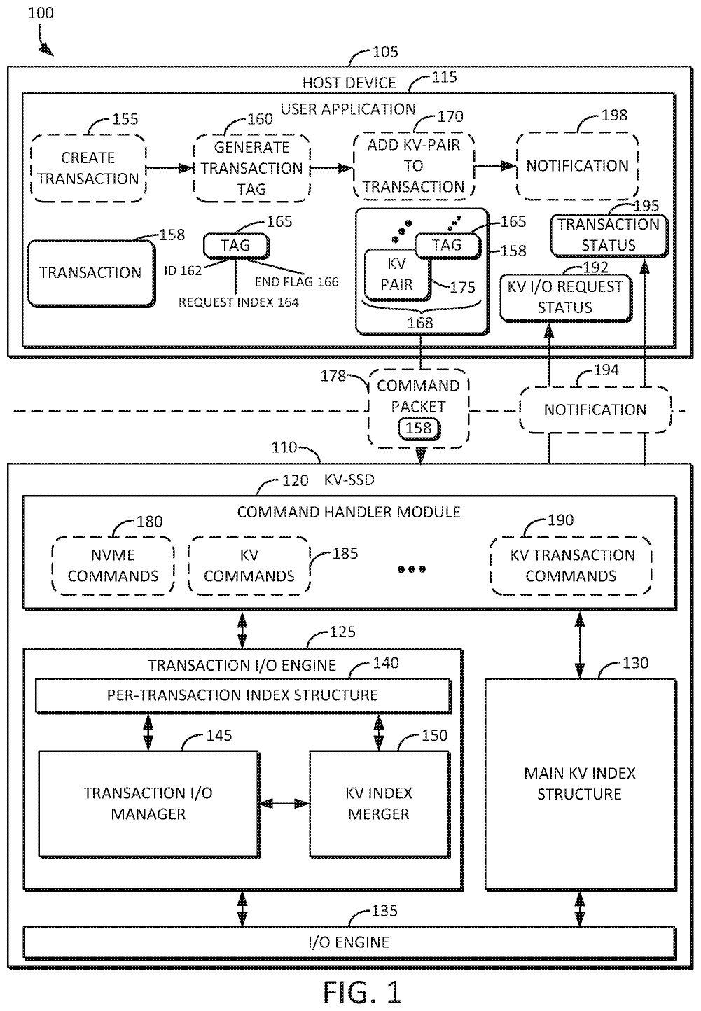

FIG. 1 illustrates a block diagram of a KV storage system 100 in accordance with some embodiments. The KV storage system 100 may include a host device 105 and a KV-SSD 110. A user application 115 may be executed by the host device 105. The user application 115 may communicate with the KV-SSD 110. The KV-SSD 110 may include a command handler module 120, a transaction input/output (I/O) engine 125, a main index structure 130, and an I/O engine 135. The transaction I/O engine 125 may include one or more per-transaction index structures 140, a transaction I/O manager 145, and a KV index merger 150.

The user application 115 may create a KV transaction 158 at 155. At 160, the user application 115 may generate a transaction tag 165. The transaction tag 165 may be an identifier of an operation belonging to a KV transaction 158. The transaction tag 165 and the KV transaction 158 can be included inside a command packet 178. The transaction tag 165 may be user-defined. The transaction tag 165 may include a user-defined transaction-ID 162 unique to a particular KV transaction 158, a request index 164 for preserving order of execution of a particular KV I/O request 168 (e.g., sequentially increasing), an end flag 166 to denote an end of the KV transaction 158, or a combination thereof. At 170, one or more KV I/O requests 168 including one or more KV pairs 175 and the corresponding one or more transaction tags 165 may be added to the KV transaction 158, after which a command packet 178 may be sent to the KV-SSD 110. The command packet 178 may include the KV transaction 158. The transaction tag 165 may be used to enforce coherency. For example, only the user application 115 that has access to the transaction tag 165 may cause a KV transaction 158 to be handled by the command handler module 120 and the transaction I/O engine 125.

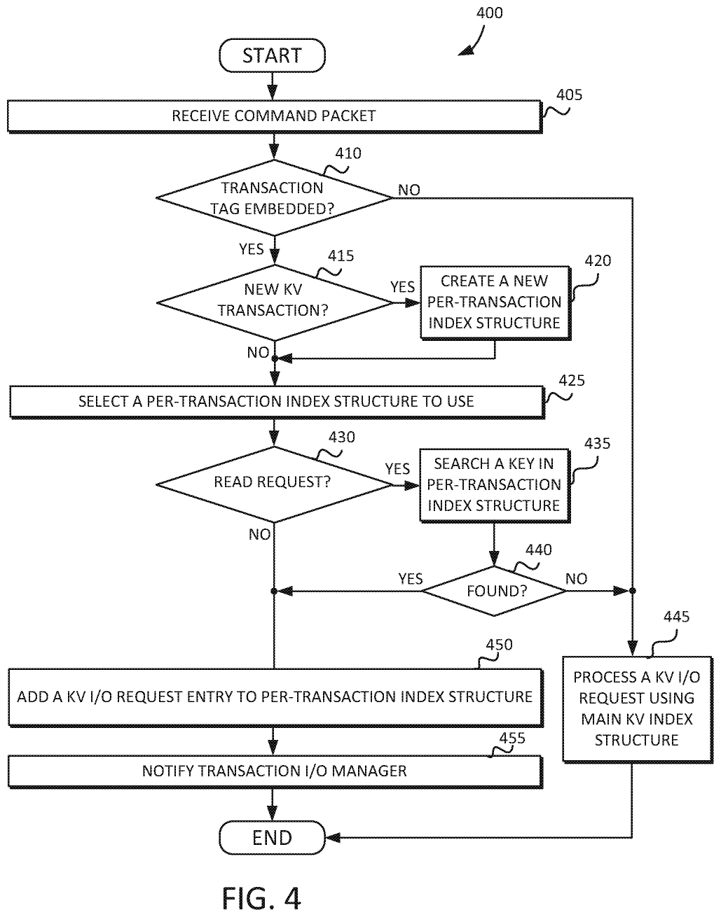

The command handler module 120 may handle different kinds of commands such as non-volatile memory express (NVME) commands 180, KV commands 185, KV transaction commands 190, or the like. The command handler module 120 may receive one or more KV I/O requests 168 from the host device 105. The command handler module 120 may detect KV transactions (e.g., 158) and take action accordingly. One of the command handler module's capabilities is to identify the one or more KV I/O requests 168 of a KV transaction 158 (e.g., KV I/O read request, KV I/O write request, etc.), prepare a per-transaction index structure 140, and handle read searches. The command handler module 120 may generate a per-transaction index structure 140 for each transaction 158. The operation of the command handler module 120 is further described below with reference to FIG. 4.

The command handler module 120 may first check for the transaction tag 165 to determine whether the command packet 178 includes a KV transaction 158 or not. In response to the command packet 178 including an operation belonging to a KV transaction 158, the command handler module 120 may check whether to create and/or select a pre-existing per-transaction index structure 140. Based on the type of the one or more KV I/O requests 168 (e.g., KV I/O read request, KV I/O write request, etc.) associated with the command packet 178, the one or more KV I/O requests 168 may be added and/or removed to and/or from the per-transaction index structure 140. The transaction I/O engine 125 may be notified to further process the KV transaction 158 added to the per-transaction index structure 140.

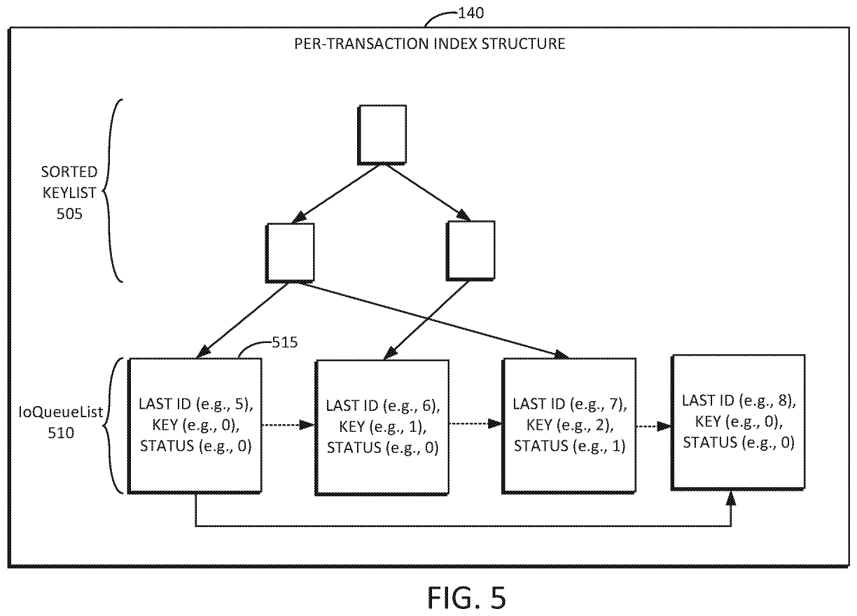

For KV I/O read requests, the command handler module 120 may search the per-transaction index structure 140 for the existence of the one or more KV I/O requests 168. In response to the one or more KV I/O requests 168 not being found in the per-transaction index structure 140, the processing may be re-directed to the main KV index structure 130 of the KV-SSD 110. The per-transaction index structure 140 may be created for some or every KV transaction 158, and identified by the transaction ID 162. The transaction ID 162 may be provided by the user application 115. The per-transaction index structure 140 may include one or more KV I/O requests 168 (e.g., individual KV pairs 175 and associated tags 165) belonging to a KV transaction 158 with the information embedded in the transaction tag 165, such as the request index 164, and type of each of the KV I/O requests 168 (e.g., KV I/O read request, KV I/O write request, etc.) parsed by the command handler module 120. Additional details of the per-transaction index structure 140 are described below with reference to FIG. 5. One responsibility of the per-transaction index structure 140 may be to provide the transaction I/O engine 125 the sequential order of requests sent by user application 115, and to maintain a data structure for efficient look-ups, particularly for read requests. The per-transaction index structure 140 may be deleted in response to the KV transaction 158 being finished, which may be indicated by the end flag 166.

The transaction I/O manager 145 may be responsible for driving (e.g., sending) the one or more KV I/O requests 168 to the device I/O engine 135 from the per-transaction index structure 140, maintaining the order of execution, consistency of operations, and/or life-cycle management of the per-transaction index structure 140. The transaction I/O manager 145 may issue one or more requests to the storage media of the KV-SSD 110. The transaction I/O manager 145 may fetch one or more KV I/O request entries from an input/output queue list (e.g., IoQueueList) of the per-transaction index-structure 140, as further described below, in order of execution. The transaction I/O manager 145 may check whether the next KV I/O request is to be issued, as further described below. In addition, the transaction I/O manager 145 may handle the completion of KV transactions 158.

The transaction I/O engine 125 may check for any failed KV I/O requests 168. In response to a KV I/O request 168 failing, a status bit of the KV transaction 158 may be set to a failed status, as further described below, denoting all further KV I/O requests 168 of the KV transaction 158 have a failed state. The transaction I/O engine 125 may send the response in a notification 194 to the user application 115. In response to each of the individual one or more KV I/O requests 168 succeeding, the one or more KV I/O requests 168 may be completed and the notification 194 may be sent to the user application 115 as they are completed. In some embodiments, the transaction I/O manager 145 causes the individual notifications 194 including the KV I/O request status 192 of completion to be sent to the user application 115. This may continue until the end flag 166 is encountered, and the KV transaction 158 as a whole may be marked to be sent to the KV index merger 150, after which the per-transaction index structure 140 may be deleted. In some embodiments, the transaction I/O manager 145 detects the end flag 166, sends the KV transaction 158 to the KV index merger 150, and deletes the per-transaction index structure 140 for that KV transaction 158. The notification 194 may be provided as a transaction status 195 to the user application 115, and a notification 198 may be provided to the host device 105 or to other applications or users.

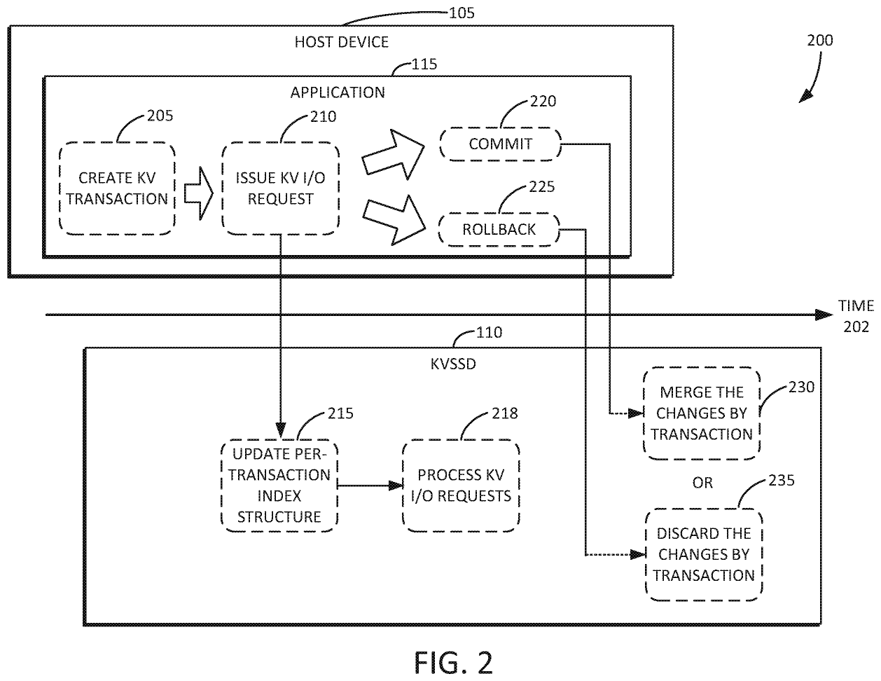

FIG. 2 is a block and flow diagram 200 illustrating a technique for processing KV transactions in accordance with some embodiments. Reference is now made to FIGS. 1 and 2.

At 205, the user application 115 on the host device 105 may create a KV transaction 158. At 210, the user application 115 may issue a KV I/O request 168. At 215, the KV-SSD 110 may update the per-transaction index structure 140, and process one or more KV I/O requests at 218. The user application 115 may either commit at 220 or rollback at 225 the KV transaction 158. In response to the user application 115 committing the KV transaction 158 at 220, the KV-SSD 110 may merge the changes associated with the KV transaction 158 at 230. In response to the user application 115 committing the KV transaction 158 at 220, the KV transaction 158 may be visible to the user application 115 and other applications. In response to the KV I/O request 168 failing, the user application 115 may decide to rollback the KV transaction 158 at 225. In response to a rollback of the KV transaction 158 at 225, the KV SSD 110 may discard the changes associated with the KV transaction 158 at 235. The interactive transaction mechanism disclosed herein may eliminate the need for transaction logging, thereby providing flexibility to choose to commit or rollback.

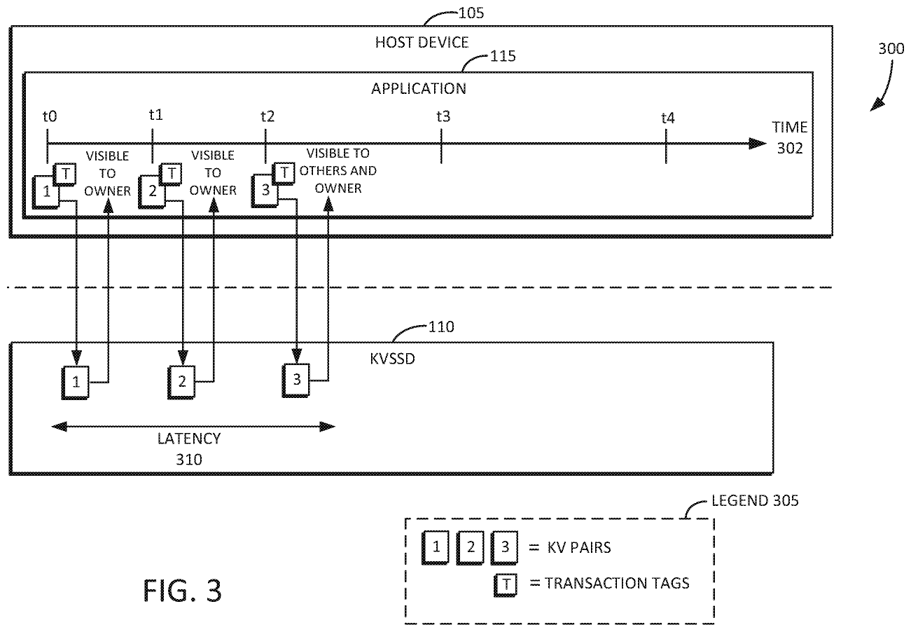

FIG. 3 is a block and flow diagram 300 illustrating a technique for performing interactive continuous in-device transaction processing using a KV-SSD 110 in accordance with some embodiments. Rather than perform a wait-batch-submit mechanism, which may benefit entropy-driven slow storage devices such as hard disk drives, an interactive continuous processing method is disclosed, which is advantageous for applications (e.g., 115), and suitable for fast KV-SSDs. As shown in the legend 305, the KV pairs are represented by boxed incrementing integers, and the transaction tags are represented by boxed ‘T’s.

At time t0, a first KV transaction 158, including a KV pair and a transaction tag, are sent from the user application 115 running on the host device 105 to the KV-SSD 110. Before time t1, status (e.g., 192 of FIG. 1) of the first KV transaction 158 may be visible to the owner (e.g., provided to the user application 115). At time t1, a second KV transaction, including a KV pair and a transaction tag, are sent from the user application 115 running on the host device 105 to the KV-SSD 110. Before time t2, status (e.g., 192 of FIG. 1) of the second KV transaction may be visible to the owner (e.g., provided to the user application 115). At time t2, a third KV transaction, including a KV pair and a transaction tag, are sent from the user application 115 running on the host device 105 to the KV-SSD 110. Before time t3, status (e.g., 192 of FIG. 1) of the third KV transaction may be visible to others and the owner (e.g., provided to the user application 115, other applications or stake holders, etc.). Overall latency is indicated at 310, but latency for each KV transaction is less than the overall latency 310.

This disclosure sets forth an in-device transaction management technique, which facilitates continuous and interactive transaction processing inside a KV storage device such as the KV-SSD 110. FIG. 3 shows an example embodiment, which unlike some batch transaction processing, allows the applications (e.g., 115) to submit individual KV I/O requests (e.g., 168 of FIG. 1) of a KV transaction (e.g., 158 of FIG. 1) with the aid of transaction-tags directly to the KV-SSD 110 without the need of staging an in host-system, while ensuring consistency. The owner of the KV transaction (e.g., 158 of FIG. 1) may have the status (e.g., 192 of FIG. 1) of each individual KV I/O request (e.g., 168 of FIG. 1) once it is persisted to the KV-SSD 110, which thereby provides the system 300 with the ability to make dynamic decisions such as adding or removing KV I/O requests (e.g., 168 of FIG. 1) based on the output. This is unlike batch-driven transaction mechanisms, where the owner may have to wait for the complete transaction to end to know the result of individual KV pair. Moreover, with the disclosed system of interactive transactions, atomic write capability of the device can be harnessed, which in the case of batch transactions may not be achieved, because if the batch becomes long, writes cannot be made atomic, and a journal or WAL may otherwise be needed to ensure consistency.

The size of each KV transaction (e.g., 158 of FIG. 1) may be reduced because there need not be any batching. Large transaction sizes may be a limiting factor when determining the size of memory in a KV-SSD. While large KV pairs can be sent as a payload to a command, the performance penalty may be high because the hardware in a KV-SSD may not fetch all of the commands in the payload. Therefore, large transactions are inefficiently handled by a KV-SSD. Reducing the transaction size as disclosed herein may therefore increase the efficiency of the KV-SSD 110.

I/O bandwidth and concurrency offered by fast non-volatile storage devices such as KV-SSDs may be underutilized due to the staging and batching requests in a transaction on the host device 105, while the KV-SSD 110 would otherwise remain idle. By performing interactive continuous in-device transaction processing, the I/O bandwidth of the KV-SSD may be better utilized. Moreover, the staging and flushing of requests that would otherwise occur in a transaction may be eliminated. Such staging and flushing may otherwise consume host-side resources such as memory and dedicated threads to push the batch-transaction to the KV-SSD, rather than processing data. Compared to wait-batch-push mechanisms, individual transaction latency can be reduced as disclosed herein, because otherwise the system may have to wait for all requests to be submitted by the user application 115, batched together, and submitted to the KV-SSD for processing.

Without in-device interactive KV transactions as disclosed herein, there may be a rigid and tight coupling between the range of a KV transaction, and few if any dynamic designs decisions can be made. For example, without the in-device interactive KV transactions as disclosed herein, no KV pairs can be added to a KV transaction based on an individual request output, as the user application 115 would otherwise need to wait for the results of the batch in order to take decisions. Some machine learning (ML)/KV applications can suffer due to this lack of dynamicity, and rigid restrictions of providing all operations a priori to a transaction.

The disclosed system ensures consistency, while overcoming the limitations of batch-driven transaction mechanisms of device underutilization, host resource consumption, and over-all latency. In addition, the disclosed system provides dynamic interactive transaction support.

FIG. 4 is a flow diagram 400 illustrating a technique for processing commands received by the command handler module 120 in accordance with some embodiments. Reference is now made to FIGS. 1 and 4.

At 405, a command packet 178 may be received. At 410, the command handler module 120 may determine whether a transaction tag 165 is embedded in the command packet 178. Based on determining that the transaction tag 165 is not embedded in the command packet 178, the flow may proceed to 445, in which a KV I/O request 168 may be processed using a main KV index structure 130. Otherwise, based on determining that the transaction tag 165 is embedded in the command packet 178, the flow may proceed to 415, and a determination may be made whether a new KV transaction is included in the command packet 178. Based on determining that the new KV transaction is included in the command packet 178, the flow may proceed to 420, in which a new per-transaction index structure 140 may be created. Otherwise, based on determining that the new KV transaction is not included in the command packet 178 (i.e., the KV transaction is not new), the flow may proceed to 425, in which an existing per-transaction index structure (e.g., 140) may be selected for use. It will be understood that the transaction I/O engine 125 can manage multiple per-transaction index structures.

At 430, the command handler module 120 may determine whether the KV transaction 158 includes a KV I/O read request. Based on determining that the KV transaction includes a KV I/O read request, the flow may proceed to 435, in which a key in the per-transaction index structure 140 may be searched. At 440, the command handler module 120 may determine whether the key in the per-transaction index structure 140 is found. Based on determining that the key in the per-transaction index structure 140 is not found, the flow may proceed to 445, in which a KV I/O request 168 may be processed using the main KV index structure 130.

Based on determining that the KV transaction does not include a KV I/O read request at 430, the flow may proceed to 450. Moreover, the flow may proceed to 450 based on determining that the key in the per-transaction index structure 140 is found at 440. At 450, a KV I/O request entry may be added to the per-transaction index structure 140. At 455, the transaction I/O manager 145 may be notified that the KV I/O request entry was added to the per-transaction index structure 140.

FIG. 5 illustrates a block diagram of a per-transaction index structure 140 in accordance with some embodiments. Reference is now made to FIGS. 1 and 5.

The per-transaction index structure 140 may be created for each transaction 158, and identified by the transaction ID 162 provided by the user application 115. The per-transaction index structure 140 may include one or more KV I/O requests 168 (e.g., individual KV pairs 175 and associated tags 165) belonging to a KV transaction 158 with the information embedded in the tag 165, such as the request index 164, and type of request (e.g., KV I/O read request, KV I/O write request, etc.) parsed by the command handler 120.

The per-transaction index structure 140 can be implemented and/or visualized as a B+ tree. The per-transaction index structure 140 may include a sorted keylist 505, which may include a sorted list of keys of one or more individual KV pairs 175. The sorted keylist 505 may aid and/or speed up key lookup. The per-transaction index structure 140 may include an IoQueueList 510, which may include a list of KV I/O requests 168 sorted based on the request index 164 for preserving an order of execution. The per-transaction index structure 140 may include a LAST ID (e.g., 5, 6, 7, 8), which may represent a most-recently-issued request index 164 to the transaction I/O engine 125 for maintaining the order. The per-transaction index structure 140 may include a STATUS bit, which may represent a status of the KV transaction 158, i.e., whether one or more KV I/O requests 168 belonging to that KV transaction 158 have failed or succeeded. For example, a STATUS bit of 1 can indicate that one or more of the KV I/O requests 168 belonging to that KV transaction 158 have failed, and a STATUS bit of 0 can indicate that the KV I/O requests 168 belonging to that KV transaction 158 have succeeded, or vice versa.

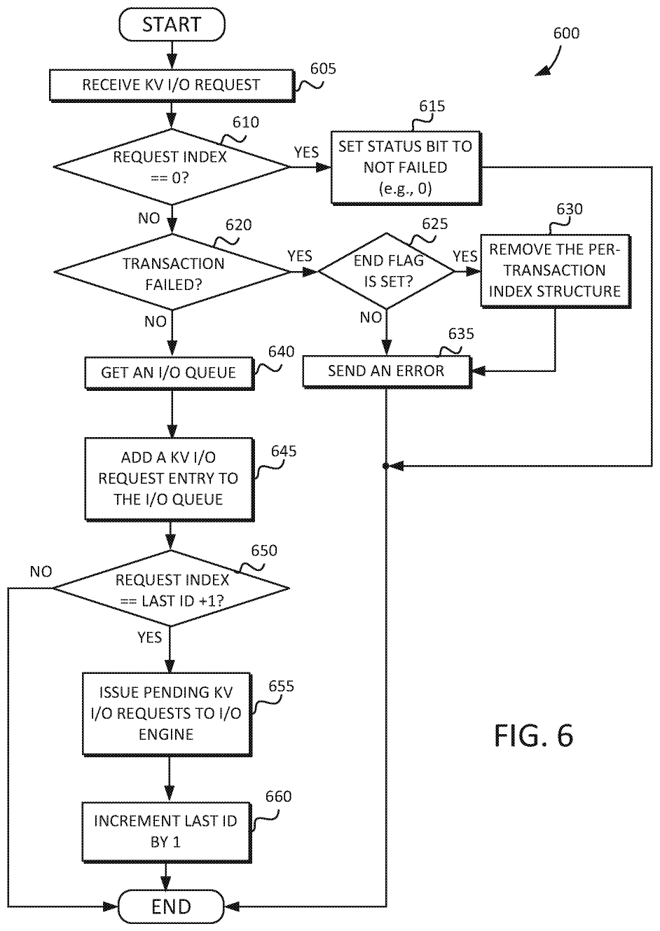

In response to the current request index 164 of a first KV I/O request entry 515 in the IoQueueList 510 being equal to (LAST ID+1), then the next KV I/O request may be issued, or the next KV I/O request may be issued after the previous KV I/O request 168 has been completed. In response to the KV I/O request 168 associated with the KV I/O request entry (e.g., 515) in the IoQueueList 510 that is equal to LAST ID being not finished, the system may wait for the completion of the KV I/O request 168, and then release the next KV I/O requests to the device I/O engine 135 for further processing, and increment the LAST ID. In response to any of the previously issued KV I/O requests having failed (e.g., the STATUS bit is set to FAILED in the corresponding KV I/O request entry), an error may be sent to the user application 115, and the per-transaction index structure 140 may be deleted if the end-flag 166 is set denoting the end of the KV transaction 158. The request handling mechanism is further described in FIG. 6 below.

FIG. 6 is a flow diagram 600 illustrating a technique for handling KV I/O requests 168 by a transaction I/O engine 125 in accordance with some embodiments. Reference is now made to FIGS. 1 and 6.

At 605, the transaction I/O engine 125 may receive a KV I/O request 168. At 610, the transaction I/O engine 125 may determine whether a request index 164 is equal to zero (0). Based on determining that the request index 164 is equal to zero (0), the transaction I/O engine 125 may set a status bit (e.g., STATUS of FIG. 5) to not failed (e.g., 0) at 615. Otherwise, based on determining that the request index 164 is not equal to zero (0), the transaction I/O engine 125 may determine at 620 whether the KV transaction 158 has failed.

Based on determining at 620 that the KV transaction 158 has failed, the flow may proceed to 625, and the transaction I/O engine 125 may determine whether an end flag 166 is set. Based on determining that the end flag 166 is set, the flow may proceed to 630, in which the per-transaction index structure 140 for that KV transaction 158 may be removed, and an error may be sent at 635 to the user application 115. Otherwise, based on determining that end flag 166 is not set, the flow may proceed directly to 635, and an error may be sent at 635 to the user application 115.

Based on determining at 620 that the KV transaction 158 has not failed, the flow may proceed to 640, in which the transaction I/O engine 125 may get an I/O queue (e.g., IoQueueList 510 of FIG. 5). At 645, the transaction I/O engine 125 may add a KV I/O request entry (e.g., 515) to the I/O queue (e.g., 510). At 650, the transaction I/O engine 125 may determine whether a request index 164 is equal to (LAST ID+1). Based on determining that the request index 164 is equal to (LAST ID+1), the flow may proceed to 655, in which the transaction I/O engine 125 may issue pending KV I/O requests (e.g., 168) to the I/O engine 135. At 660, the transaction I/O engine 125 may increment LAST ID (e.g., of FIG. 5) by one (1). Based on determining at 650 that the request index 164 is not equal to (LAST ID+1), the flow may proceed directly to END.

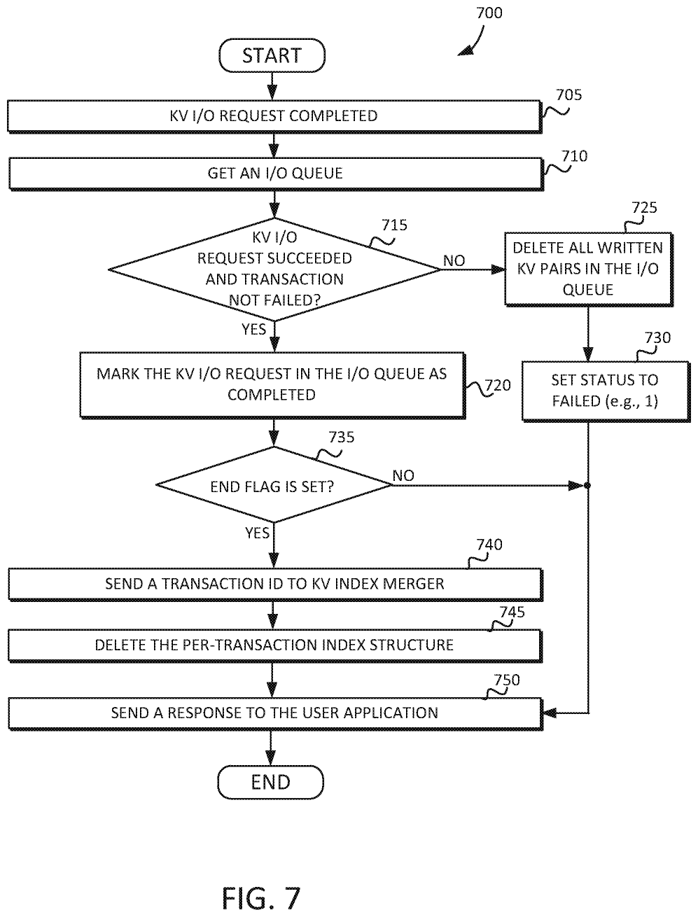

FIG. 7 is a flow diagram 700 illustrating a technique for completing KV transactions 158 sent to the KV-SSD 110 in accordance with some embodiments. Reference is now made to FIGS. 1 and 7.

After the I/O engine 135 completes a KV transaction 158 involving one or more KV I/O requests 168 at 705, the I/O engine 135 may provide a response, and the transaction I/O engine 125 may receive the response from the I/O engine 135. The transaction I/O engine 125 may then get an I/O queue (e.g., IoQueueList 510 of FIG. 5) at 710. At 715, the transaction I/O engine 125 may determine whether a KV I/O request 168 succeeded and the KV transaction 158 did not fail. Based on determining that the KV I/O request 168 succeeded and the KV transaction 158 did not fail, the flow may proceed to 720, in which the KV I/O request 168 in the I/O queue (e.g., IoQueueList 510 of FIG. 5) may be marked as completed. Otherwise, based on determining that the KV I/O request 168 did not succeed or the KV transaction 158 failed, the flow may proceed to 725, in which all written KV pairs in the I/O queue (e.g., IoQueueList 510 of FIG. 5) may be deleted. The status bit (e.g., STATUS of FIG. 5) may then be set to failed (e.g., 1) at 730, and a response sent to the user application at 115.

After the request in the I/O queue (e.g., IoQueueList 510 of FIG. 5) is marked as completed at 720, the flow may proceed to 735, in which the transaction I/O engine 125 may determine whether the end flag 166 is set. Based on determining that the end flag 166 is not set, the flow may proceed to 750, in which a response may be sent to the user application at 115. Otherwise, based on determining that the end flag 166 is set, the flow may proceed to 740, in which the transaction ID 162 may be sent to the KV index merger 150. At 745, the per-transaction index structure 140 associated with the transaction ID 162 may be deleted. At 750, a response may be sent to the user application at 115.

The KV index merger 150 may merge the successfully written keys of the KV pairs 175 from the per-transaction index-structure 140 to the main KV index structure 130 after all of the individual KV I/O requests 168 in a KV transaction 158 are completed. After the keys are merged, the per-transaction index structure 140 may be deleted and the transaction status 195 may be made available to all stake holders (e.g., user application and/or others) to view. In some embodiments, the transaction I/O manager 145 causes the transaction status 195 to be made available to the stake holders.

The various operations of methods described above may be performed by any suitable means capable of performing the operations, such as various hardware and/or software component(s), circuits, and/or module(s).

Some embodiments may include an interactive continuous in-device key-value (KV) transaction processing system. The system may include a host device configured to generate a command packet. The system may include a KV solid state drive (KV-SSD) including a command handler module configured to receive the command packet from the host device, to detect a KV transaction within the command packet, to identify one or more KV input/output (I/O) requests associated with the KV transaction, and to at least one of i) prepare a new per-transaction index structure or ii) select a pre-existing per-transaction index structure associated with the KV transaction.

In some embodiments, the command handler module is configured to add the one or more KV I/O requests to the per-transaction index structure. In some embodiments, the command handler module is configured to remove the one or more KV I/O requests from the per-transaction index structure. The system may further include a transaction I/O engine configured to individually process the one or more KV I/O requests of the per-transaction index structure. In some embodiments, the transaction I/O engine includes a transaction I/O manager configured to send the one or more KV I/O requests from the per-transaction index structure to a device I/O engine of the KV-SSD, and to maintain an order of execution of the one or more KV I/O requests. In some embodiments, the transaction I/O manager is further configured to send an individual notification to the host device including an individual status of completion of each of the individual one or more KV I/O requests as they are completed. In some embodiments, the transaction I/O engine includes a KV index merger. The transaction I/O manager may be further configured to detect an end flag associated with the one or more KV I/O requests. The transaction I/O manager may be further configured to complete the processing of the one or more KV I/O requests. The transaction I/O manager may be further configured to send a transaction ID associated with the KV transaction to the KV index merger. The transaction I/O manager may be further configured to delete the per-transaction index structure based on the transaction ID.

The KV-SSD may further include a main KV index structure. In some embodiments, the KV index merger is configured to merge, based on the transaction ID, one or more KV pairs associated with the one or more KV I/O requests associated with the KV transaction to the main KV index structure. In some embodiments, the host device is configured to at least one of i) commit or ii) rollback the KV transaction.

Some embodiments include a method for processing an interactive continuous in-device key-value (KV) transaction. The method may include receiving, by a command handler module of a KV solid state drive (KV-SSD), a command packet. The method may include determining, by the command handler module, whether a transaction tag associated with a KV transaction is embedded in the command packet. The method may include, based on determining that the transaction tag is not embedded in the command packet, processing one or more KV I/O requests associated with the KV transaction using a main KV index structure. The method may include, based on determining that the transaction tag is embedded in the command packet, processing the one or more KV I/O requests associated with the KV transaction.

The method may include determining, by the command handler module, whether the KV transaction is a new KV transaction. The method may include, based on determining that the KV transaction is the new KV transaction, creating a new per-transaction index structure, and processing the one or more KV I/O requests associated with the KV transaction using the new per-transaction index structure. The method may include, based on determining that the KV transaction is not the new KV transaction, selecting a pre-existing per-transaction index structure, and processing the one or more KV I/O requests associated with the KV transaction using the pre-existing per-transaction index structure.

The method may include determining, by the command handler module, whether the KV transaction includes a KV I/O read request. The method may include, based on determining that the KV transaction includes the KV I/O read request, searching for a key in at least one of i) the new per-transaction index structure, or ii) the pre-existing per-transaction index structure. The method may include, responsive to not finding the key in the at least one of i) the new per-transaction index structure, or ii) the pre-existing per-transaction index structure, processing the one or more KV I/O requests associated with the KV transaction using the main KV index structure. The method may include, responsive to finding the key in the at least one of i) the new per-transaction index structure, or ii) the pre-existing per-transaction index structure, adding an entry associated with the one or more KV I/O requests to the at least one of i) the new per-transaction index structure, or ii) the pre-existing per-transaction index structure, and processing the one or more KV I/O requests associated with the KV transaction using the main KV index structure.

The method may include sending, by a transaction I/O manager of a transaction I/O engine of the KV-SSD, the one or more KV I/O requests to an I/O engine of the KV-SSD. The method may include maintaining, by the transaction I/O manager, an order of execution of the one or more KV I/O requests. The method may include sending, by the transaction I/O manager, an individual notification to a host device including an individual status of completion of each of the individual one or more KV I/O requests as they are completed. The method may include detecting, by the transaction I/O manager, an end flag associated with the one or more KV I/O requests. The method may include completing processing of the one or more KV I/O requests. The method may include sending a transaction ID associated with the KV transaction to a KV index merger of the transaction I/O engine. The method may include deleting, based on the transaction ID, the at least one of i) the new per-transaction index structure, or ii) the pre-existing per-transaction index structure.

The method may include merging, by the KV index merger, based on the transaction ID, one or more KV pairs associated with the one or more KV I/O requests associated with the KV transaction to the main KV index structure. The method may include providing a notification to the host device including a transaction status of completion associated with the KV transaction. The method may include committing, by the host device, the KV transaction. The method may include rolling back, by the host device, the KV transaction.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

The following discussion is intended to provide a brief, general description of a suitable machine or machines in which certain aspects of the inventive concept can be implemented. Typically, the machine or machines include a system bus to which is attached processors, memory, e.g., RAM, ROM, or other state preserving medium, storage devices, a video interface, and input/output interface ports. The machine or machines can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines can include embedded controllers, such as programmable or non-programmable logic devices or arrays, Application Specific Integrated Circuits (ASICs), embedded computers, smart cards, and the like. The machine or machines can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth®, optical, infrared, cable, laser, etc.

Embodiments of the present disclosure can be described by reference to or in conjunction with associated data including functions, procedures, data structures, application programs, etc. which when accessed by a machine results in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the present disclosure with reference to illustrated embodiments, it will be recognized that the illustrated embodiments can be modified in arrangement and detail without departing from such principles, and can be combined in any desired manner. And although the foregoing discussion has focused on particular embodiments, other configurations are contemplated. In particular, even though expressions such as “according to an embodiment of the inventive concept” or the like are used herein, these phrases are meant to generally reference embodiment possibilities, and are not intended to limit the inventive concept to particular embodiment configurations. As used herein, these terms can reference the same or different embodiments that are combinable into other embodiments.

Embodiments of the present disclosure may include a non-transitory machine-readable medium comprising instructions executable by one or more processors, the instructions comprising instructions to perform the elements of the inventive concepts as described herein.

The foregoing illustrative embodiments are not to be construed as limiting the inventive concept thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this present disclosure as defined in the claims.

What is claimed is:

1. An interactive continuous in-device key-value (KV) transaction processing system, comprising:
a host device configured to generate a command packet; and
a KV solid state drive (KV-SSD) including a command handler module configured to receive the command packet from the host device, to detect a KV transaction within the command packet, to identify one or more KV input/output (I/O) requests associated with the KV transaction, and to at least one of i) prepare a new per-transaction index structure or ii) select a pre-existing per-transaction index structure associated with the KV transaction.

2. The system of claim 1, wherein the command handler module is configured to add the one or more KV I/O requests to the per-transaction index structure.

3. The system of claim 2, wherein the command handler module is configured to remove the one or more KV I/O requests from the per-transaction index structure.

4. The system of claim 2, further comprising a transaction I/O engine configured to individually process the one or more KV I/O requests of the per-transaction index structure.

5. The system of claim 4, wherein the transaction I/O engine includes a transaction I/O manager configured to send the one or more KV I/O requests from the per-transaction index structure to a device I/O engine of the KV-SSD, and to maintain an order of execution of the one or more KV I/O requests.

6. The system of claim 5, wherein the transaction I/O manager is further configured to send an individual notification to the host device including an individual status of completion of each of the individual one or more KV I/O requests as they are completed.

7. The system of claim 4, wherein the transaction I/O engine includes a KV index merger, and the transaction I/O manager is further configured to:
detect an end flag associated with the one or more KV I/O requests;
complete the processing of the one or more KV I/O requests;
send a transaction ID associated with the KV transaction to the KV index merger; and
delete the per-transaction index structure based on the transaction ID.

8. The system of claim 7, further comprising a main KV index structure, wherein the KV index merger is configured to merge, based on the transaction ID, one or more KV pairs associated with the one or more KV I/O requests associated with the KV transaction to the main KV index structure.

9. The system of claim 1, wherein the host device is configured to at least one of i) commit or ii) rollback the KV transaction.

10. A method for processing an interactive continuous in-device key-value (KV) transaction, the method comprising:
receiving, by a command handler module of a KV solid state drive (KV-SSD), a command packet;
determining, by the command handler module, whether a transaction tag associated with a KV transaction is embedded in the command packet;
based on determining that the transaction tag is embedded in the command packet, processing one or more KV I/O requests associated with the KV transaction.

11. The method of claim 10, wherein the command packet is a first command packet, the method further comprising:
receiving, by the command handler module, a second command packet;
determining, by the command handler module, whether the transaction tag associated with the KV transaction is embedded in the second command packet;
based on determining that the transaction tag is not embedded in the second command packet, processing the one or more KV I/O requests associated with the KV transaction using a main KV index structure.

12. The method of claim 10, further comprising:
determining, by the command handler module, whether the KV transaction is a new KV transaction;
based on determining that the KV transaction is the new KV transaction, creating a new per-transaction index structure, and processing the one or more KV I/O requests associated with the KV transaction using the new per-transaction index structure; and
based on determining that the KV transaction is not the new KV transaction, selecting a pre-existing per-transaction index structure, and processing the one or more KV I/O requests associated with the KV transaction using the pre-existing per-transaction index structure.

13. The method of claim 12, further comprising:
determining, by the command handler module, whether the KV transaction includes a KV I/O read request; and
based on determining that the KV transaction includes the KV I/O read request, searching for a key in at least one of i) the new per-transaction index structure, or ii) the pre-existing per-transaction index structure.

14. The method of claim 13, further comprising:
responsive to not finding the key in the at least one of i) the new per-transaction index structure, or ii) the pre-existing per-transaction index structure, processing the one or more KV I/O requests associated with the KV transaction using the main KV index structure.

15. The method of claim 13, further comprising:
responsive to finding the key in the at least one of i) the new per-transaction index structure, or ii) the pre-existing per-transaction index structure, adding an entry associated with the one or more KV I/O requests to the at least one of i) the new per-transaction index structure, or ii) the pre-existing per-transaction index structure, and processing the one or more KV I/O requests associated with the KV transaction using the main KV index structure.

16. The method of claim 13, further comprising:
sending, by a transaction I/O manager of a transaction I/O engine of the KV-SSD, the one or more KV I/O requests to an I/O engine of the KV-SSD; and
maintaining, by the transaction I/O manager, an order of execution of the one or more KV I/O requests.

17. The method of claim 16, further comprising:
sending, by the transaction I/O manager, an individual notification to a host device including an individual status of completion of each of the individual one or more KV I/O requests as they are completed;
detecting, by the transaction I/O manager, an end flag associated with the one or more KV I/O requests;
completing processing of the one or more KV I/O requests;
sending a transaction ID associated with the KV transaction to a KV index merger of the transaction I/O engine; and
deleting, based on the transaction ID, the at least one of i) the new per-transaction index structure, or ii) the pre-existing per-transaction index structure.

18. The method of claim 17, further comprising merging, by the KV index merger, based on the transaction ID, one or more KV pairs associated with the one or more KV I/O requests associated with the KV transaction to the main KV index structure.

19. The method of claim 17, further comprising providing a notification to the host device including a transaction status of completion associated with the KV transaction.

20. The method of claim 17, further comprising committing, by the host device, the KV transaction.

21. The method of claim 17, further comprising rolling back, by the host device, the KV transaction.
